(19) United States
(12) Patent Application Publication
(10) Pub. No.: US 2026/0115673 A1
(43) Pub. Date: Apr. 30, 2026

(54) PREPARATION METHOD OF C-ZIF-67-DERIVED NANO-POROUS CARBON DOPED PDMS MIXED MATRIX MEMBRANE BASED ON TUBULAR CERAMIC CARRIER AND APPLICATION OF PERVAPORATION TO RECOVER ETHANOL

(71) Applicant: Jilin University of Chemical Technology, Jilin City (CN)

(72) Inventors: Bo YUAN, Jilin City (CN); Yuzhuang LI, Jilin City (CN); Jiaxuan GOU, Jilin City (CN); Yu ZHANG, Jilin City (CN); Qun LIU, Jilin City (CN)

(73) Assignee: Jilin University of Chemical Technology, Jilin City (CN)

(21) Appl. No.: 19/367,850

(22) Filed: Oct. 24, 2025

Related U.S. Application Data
(63) Continuation of application No. PCT/CN2025/119685, filed on Sep. 8, 2025.

(30) Foreign Application Priority Data
Oct. 29, 2024 (CN) 2024115183051

(51) Int. Cl. B01D 71/70; B01D 67/00; B01D 69/04; B01D 69/10; B01D 69/14; B01D 71/02

(52) U.S. Cl. CPC B01D 71/701; B01D 67/0083; B01D 67/0088; B01D 67/0095; B01D 69/04; B01D 69/108; B01D 69/148; B01D 71/028

(57) ABSTRACT

Described herein is a preparation method of C-ZIF-67-derived nano-porous carbon doped PDMS mixed matrix membrane based on a tubular ceramic carrier and its application in pervaporation of low-concentration ethanol aqueous solution to recover ethanol by synthesizing ZIF-67 crystals and carbonizing the ZIF-67 crystal to obtain C-ZIF-67 filler particles. According to the present application, the nano-porous carbon particles derived from ZIF-67 are prepared by a high-temperature calcination method, and are fully carbonized at a certain calcination temperature, so that the disappearance of characteristic groups after carbonization can reduce the influence of surface electrical properties, and the particle size is reduced. At the same time, the MOF skeleton structure is still retained after carbonization, the pore size is enlarged, and the carbon material also has strong hydrophobicity.

### CROSS-REFERENCE TO RELATED APPLICATIONS

This application is a continuation of International Patent Application No. PCT/CN2025/119685, filed on Sep. 8, 2025, which in turn claims priority to Chinese Patent Application No. 202411518305.1, filed on Oct. 29, 2024, the contents of which are incorporated by reference herein in their entirety.

### TECHNICAL FIELD

The present application belongs to the technical field of ethanol recovery, and relates to a mixed matrix membrane for pervaporation recovery of ethanol and a preparation method thereof, in particular to a preparation method of C-ZIF-67-derived nano-porous carbon doped PDMS mixed matrix membrane based on a tubular ceramic carrier and its application in pervaporation recovery of ethanol from low-concentration ethanol aqueous solution.

### BACKGROUND

The excessive dependence on fossil fuels in today's world has caused serious energy crisis and environmental problems. Renewable biomass has attracted much attention as an alternative resource, and bioethanol, as a valuable biofuel, has great market potential. However, its fermentation, production and separation technologies are currently facing challenges, such as end product inhibition and high energy-consuming distillation process.

Pervaporation is a promising membrane separation technology, which has the advantages of simple operation, low energy consumption, high efficiency and no toxicity. Polydimethylsiloxane (PDMS) membrane has been widely studied because of its strong hydrophobicity, good permeability and stability, and low cost. However, the ethanol separation performance of traditional PDMS membrane is insufficient, which limits its large-scale application.

Mixing fillers into PDMS to prepare mixed matrix membrane (MMM) can improve the membrane performance. As a doping filler, metal-organic framework (MOFs) is widely used in the preparation of MMM. For example, ZIF-67 has high specific surface area, adjustable pore size and small size structure, strong hydrophobicity, and can be easily synthesized at room temperature, so it can be used as a doping filler. A great deal of research has focused on the synthesis of MMMs with sheet-like support and its pervaporation separation of ethanol aqueous solution, but the research on using tubular ceramic support is still lacking. It has the advantages of strong chemical stability and high mechanical strength, and is widely used in the current industrial production (tubular membranes are used for industrial production).

Initially, ZIF-67/PDMS MMM is prepared with ceramic tube as carrier, and it is applied to pervaporation separation of low concentration ethanol aqueous solution, but there are some shortcomings:
(1) ZIF-67 particles are seriously agglomerated on the tubular carrier, so that the improvement of separation factor is limited;
(2) The interfacial compatibility between ZIF-67 and PDMS is not ideal, and the stability is reduced.

The application aims at solving the problems existing in the separation of PDMS membrane and ZIF-67/PDMS MMM in low-concentration ethanol aqueous solution in the prior art, such as the agglomeration of ZIF-67 particles, unsatisfactory interfacial compatibility and the like, and provides a mixed matrix membrane with better performance and a preparation method thereof.

### SUMMARY

In order to make up for the shortcomings of the prior art, the application firstly prepares ZIF-67/PDMS MMM with ceramic tube as carrier, and applies it to pervaporation separation of low-concentration ethanol aqueous solution, but there are some shortcomings:

(1) ZIF-67 particles are seriously agglomerated on the tubular carrier, so that the improvement of separation factor is limited;
(2) The interfacial compatibility between ZIF-67 and PDMS is not ideal, and the stability is reduced.

The reasons for the deficiency are further analyzed:

ZIF-67 particles are easy to agglomerate (this phenomenon is obvious in the process of synthesizing ZIF-67 in this study), which is caused by the electrical effect of the surface groups of zeolite-imidazole salt skeleton structure, so the agglomeration in PDMS matrix membrane is seriously poor in dispersibility; this further affected the compatibility between it and PDMS, resulting in some defects on the surface of the membrane, and some ZIF-67 fell off after long-term use, which reduces the stability.

The solution of this case is: keep the porous skeleton structure of ZIF-67, eliminate the role of surface groups, and at the same time, not reduce its hydrophobic properties; therefore, it is considered that the nano-porous carbon particles derived from ZIF-67 are prepared by high-temperature calcination, and they are fully carbonized at a certain calcination temperature. After carbonization, the disappearance of characteristic groups can reduce the influence of their surface electrical properties, and the particle size is reduced, which is conducive to the improvement of their dispersion in the matrix membrane; at the same time, the MOF skeleton structure is still retained after carbonization, and the pore size becomes larger, and the carbon material also has strong hydrophobicity. These hydrophobic large-pore separation channels are more conducive to the passage of ethanol molecules and promote the separation effect.

The technical scheme adopted by the application to solve the technical problem is that the preparation method of C-ZIF-67-derived nano-porous carbon doped PDMS mixed matrix membrane based on tubular ceramic carrier comprises the following steps:
S1, synthesizing ZIF-67 crystal, and dissolving Co(NO₃)₂·6H₂O in methanol; then dissolving Hmim in methanol; then, the two solutions were mixed and stirred continuously for 2 h at room temperature to obtain purple crystals, the obtained purple crystals were centrifuged at 8000 rpm for 10 min to collect products, washed repeatedly with methanol, and finally the obtained crystals were dried in vacuum at 80° C. overnight to obtain ZIF-67 crystals;
S2: preparation of C-ZIF-67 filler particles: the synthesized ZIF-67 crystals are carbonized and collected, the collected particles are washed with methanol to remove residues, and finally, the C-ZIF-67 filler particles are obtained by vacuum drying at 80° C. overnight;
S3: treatment of the α-alumina ceramic tube carrier: firstly, the ceramic tube is polished with 800 #coarse sandpaper and 1500 #fine sandpaper respectively, and then the impurities are removed by calcination, and then the α-alumina ceramic tube carrier is obtained by ultrasonic cleaning for 5 min and cleaning with pure water. Before use, the α-alumina ceramic tube carrier is soaked in pure water, and when needed, the excess water on the surface of the α-alumina ceramic tube carrier is wiped off with filter paper, and left to dry for later use;
S4: preparing a PDMS-based mixed matrix membrane: adding C-ZIF-67 filler particles into n-heptane, stirring, performing ultrasonic treatment for 1 h, adding PDMS and stirring for 4 h, adding PDMS into the mixed solution again, and stirring for 12 h; subsequently, TEOS as a cross-linking agent and DBTOL as a catalyst are added respectively, and then the solution is allowed to stand for defoaming. The PDMS solution filled with C-ZIF-67 is coated on the outer surface of α-alumina ceramic tube carrier for 1 min by dip coating, and then it is allowed to stand at room temperature for 24 h, and then it is dried in vacuum at 90° C. for 12 h. Finally, the C-ZIF-67-derived nano-porous carbon doped PDMS mixed matrix membrane is prepared.

Further, 0.1-0.4 g of Co (NO₃)₂·6H₂O; 10-15 g of methanol; 0.2-0.5 g of Hmim.

Further, 0.29 g of Co (NO₃)₂·6H₂O; 11.8 g of Methanol; 0.33 g of Hmim.

Further, the conditions for carbonization of the ZIF-67 crystal in S2 are that the initial temperature is room temperature, the temperature is raised in nitrogen environment at a rate of 5° C.·min⁻¹, the temperature is raised to 700° C., then the temperature is kept for 2 h, and then the temperature is naturally lowered.

Furthermore, 0.1-0.3 g of C-ZIF-67 filler particles, 20-30 g of n-heptane and 1-3 g of PDMS are added in total, the first addition amount for PDMS is 10% of the mass of the filler particles, and the second addition amount is the remaining PDMS mass.

Furthermore, 0.2625 g of the particle mass of C-ZIF-67 fillers, 25 g of the mass of n-heptane, and 1.75 g of the total mass of PDMS.

Furthermore, the mass ratio of PDMS, TEOS and DBTOL is 1:0.1:0.05.

The application of pervaporation to recover ethanol is wherein the prepared C-ZIF-67-derived nanoporous carbondoped into PDMS mixed matrix membrane based on tubular ceramic carrier is employed, and ethanol is recovered through pervaporation.

The application has the following beneficial effects:

According to the preparation method of C-ZIF-67-derived nano-porous carbon doped into PDMS mixed matrix membrane based on tubular ceramic carrier and the application of pervaporation to recover ethanol, the prepared particles in C-ZIF-67/PDMS MMM retain the skeleton structure of the original MOF, and the pore size is enlarged, and meanwhile, the carbon component has strong hydrophobicity, relatively good dispersibility and better compatibility with PDMS; compared with pure PDMS membrane and ZIF-67/PDMSMMM, the pervaporation performance of C-ZIF-67/PDMS MMM for ethanol/water solution is significantly improved. Moreover, the separation factor and total flux remain almost unchanged after long-term operation, showing excellent performance and good application prospects.

### BRIEF DESCRIPTION OF THE DRAWINGS

The application will be further explained with the attached drawings.

FIG. 1 is a flow chart of the method of the present application.

FIG. 2 is a schematic diagram of the pervaporation performance testing device of the present application.

FIG. 3A is the XRD pattern of ZIF-67 particles of the present application.

FIG. 3B is the TGA curve of ZIF-67 particles of the present application.

FIG. 3C is the XRD pattern of C-ZIF-67 particles of the present application.

FIG. 4 is an infrared spectrum of ZIF-67 and C-ZIF-67 particles of the present application.

FIG. 5A is a scanning electron microscope diagram of ZIF-67 particles of the present application.

FIG. 5B is a scanning electron microscope diagram of C-ZIF-67 particles of the present application.

FIG. 6A is the N₂ adsorption and desorption isotherm of ZIF-67 particles of the present application.

FIG. 6B is the N₂ adsorption and desorption isotherm of C-ZIF-67 particles of the present application.

FIG. 6C is the pore size distribution diagram of the present application.

FIG. 7A shows a scanning electron microscope image of PDMS surface of the present application.

FIG. 7B shows a scanning electron microscope image of PDMS cross section of the present application.

FIG. 7C shows a scanning electron microscope image of the surface of ZIF-67/PDMS-15 wt % MMM of the present application.

FIG. 7D shows a scanning electron microscope image of the cross section of ZIF-67/PDMS-15 wt % MMM of the present application.

FIG. 7E shows a scanning electron microscope image of the surface of C-ZIF-67/PDMS-15 wt % MMM of the present application.

FIG. 7F shows a scanning electron microscope image of the cross section of C-ZIF-67/PDMS-15 wt % MMM of the present application.

FIG. 8 is the water contact angle diagrams of pure PDMS membrane, ZIF-67/PDMS-15 wt % and C-ZIF-67/PDMS MMMs with different loadings.

FIG. 9A is the flux and separation factor of ZIF-67/PDMS-15 wt % MMM with different loadings.

FIG. 9B is the flux and separation factor of C-ZIF-67/PDMS-15 wt % MMM with different loadings.

FIG. 10 is a comparison chart of pervaporation performance of pure PDMS membrane, ZIF-67/PDMS-15 wt % and C-ZIF-67/PDMS-15 wt % MMMs of the present application.

FIG. 11 is a long-term pervaporation performance chart of C-ZIF-67/PDMS-15 wt % MMM of the present application.

### DETAILED DESCRIPTION OF THE EMBODIMENTS

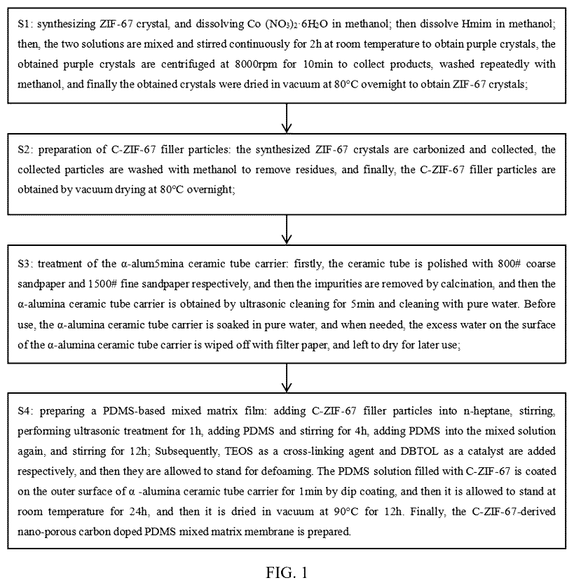

In order to make the technical means, creative features, goals and effects of the present application easy to understand, the present application will be further elaborated with specific examples and comparative embodiments as shown in FIGS. 1-11.

### Embodiment 1

As shown in FIG. 1, the preparation of C-ZIF-67-derived nanoporous carbon doped PDMS mixed matrix membrane based on tubular ceramic carrier:

Synthesis of ZIF-67 crystal: dissolving 0.29 g of Co (NO₃)₂·6H₂O in 11.8 g of methanol; then 0.33 g Hmim was dissolved in 11.8 g methanol; then, the two solutions were mixed and stirred at room temperature for 2 h to obtain purple crystals. The products were collected by centrifugation at 8000 rpm for 10 min, and washed repeatedly with methanol. Finally, the obtained crystals are dried in vacuum at 80° C. overnight to obtain ZIF-67 crystals.

Carbonization of ZIF-67 crystal: the synthesized ZIF-67 crystal is heated at the initial room temperature in nitrogen environment at a heating rate of 5° C.·min⁻¹, and then kept at 700° C. for 2 h, then cooled naturally, and the carbonized particles are collected and washed with methanol to remove residues, and finally dried in vacuum at 80° C. overnight to obtain C-ZIF-67 filler particles.

Treatment of α-alumina ceramic tube carrier: firstly, the ceramic tube was polished with coarse sandpaper (800 #) and fine sandpaper (1500 #) respectively, then calcined to remove impurities, then washed with pure water for 5 min, then soaked in pure water for 24 h, filled the holes of the carrier with water to prevent the coating polymer solution from penetrating into the holes, and took it out 1 h before soaking the coating polymer solution, wiped off the excess water on the surface of the ceramic tube with filter paper, and stood for drying.

Preparation of PDMS-based mixed matrix membrane: 0.2625 g of C-ZIF-67 filler particles were added into 25 g of n-heptane, and then ultrasonic treatment was performed for 1 h after stirring. Then a part of PDMS (10% of the mass of filler particles) was added and stirred for 4 h, and then the remaining PDMS was added to the mixed solution and stirred for 12 h. The total mass of PDMS added was 1.75 g (7.0 wt % PDMS concentration of n-heptane). Subsequently, the crosslinking agent TEOS and the catalyst DBTOL (the ratio of PDMS/TEOS/DBTOL is 1/0.1/0.05) were added respectively, and the mixture was allowed to stand for defoaming. The PDMS solution filled with C-ZIF-67 was coated on the outer surface of the treated α-alumina ceramic tube carrier for 1 min by dip coating. Standing at room temperature for 24 h, then vacuum drying at 90° C. for 12 h, and finally preparing C-ZIF-67 filled PDMS/ceramic tube mixed matrix membrane.

### Comparative Embodiment 1

Preparation of PDMS/Ceramic Tube Mixed Matrix Membrane Filled with ZIF-67;

Synthesis of ZIF-67 crystal: dissolving 0.29 g of Co (NO₃)₂·6H₂O in 11.8 g of methanol; then 0.33 g Hmim was dissolved in 11.8 g methanol; then, the two solutions were mixed and stirred at room temperature for 2 h to obtain purple crystals. The products were collected by centrifugation at 8000 rpm for 10 min, and washed repeatedly with methanol. Finally, the obtained crystals were dried in vacuum at 80° C. overnight to obtain ZIF-67 crystals.

Treatment of α-alumina ceramic tube carrier: firstly, the ceramic tube was polished with coarse sandpaper (800 #) and fine sandpaper (1500 #) respectively, then calcined to remove impurities, then washed with pure water for 5 min, then soaked in pure water for 24 h, filled the holes of the carrier with water to prevent the coating polymer solution from penetrating into the holes, and took it out 1 h before soaking the coating polymer solution, wiped off the excess water on the surface of the ceramic tube with filter paper, and stood for drying.

Preparation of PDMS-based mixed matrix membrane: 0.2625 g of C-ZIF-67 filler particles were added to 25 g of n-heptane, and then ultrasonic treatment was performed for 1 h after stirring. Then, a part of PDMS (10% of the mass of filler particles) was added, and the mixture was stirred for 4 h. Then, the remaining PDMS was added to the mixed solution and stirred for 12 h. The total mass of PDMS added was 1.75 g (7.0 wt % PDMS concentration of n-heptane). Subsequently, the crosslinking agent TEOS and the catalyst DBTOL (the ratio of PDMS/TEOS/DBTOL is 1/0.1/0.05) were added respectively, and the mixture was allowed to stand for defoaming. The PDMS solution filled with ZIF-67 was coated on the outer surface of the treated α-alumina ceramic tube carrier for 1 min by dip coating. Standing at room temperature for 24 h, then vacuum drying at 90° C. for 12 h, and finally preparing the mixed matrix membrane of PDMS/ceramic tube filled with ZIF-67.

### Comparative Embodiment 2

Preparation of pure PDMS membrane: 1.75 g PDMS was added into 25 g n-heptane, stirred at room temperature for 6 h, then the crosslinking agent TEOS and the catalyst DBTOL (the ratio of PDMS/TEOS/DBTOL was 1/0.1/0.05) were added respectively, and stood for defoaming; the PDMS solution was coated on the outer surface of the pretreated tubular ceramic carrier by dip coating for 1 min; standing at room temperature for 24 h, then vacuum drying at 90° C. for 12 h, and finally preparing pure PDMS membrane.

Pervaporation experiments were carried out on the membranes prepared in Embodiment, Comparative Embodiment 1 and Comparative embodiment 2, as follows:

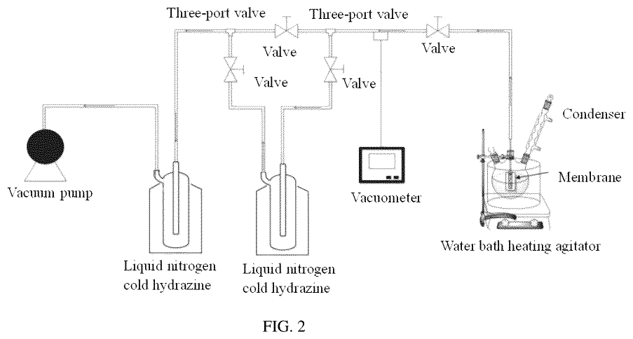

As shown in FIG. 2, the tubular membrane is connected with the stainless steel tube with vacuum sealant, and then installed in the pervaporation device, with an effective membrane area of 0.001695 m²; the feed solution is 5 wt % ethanol water solution, the temperature is controlled at 60° C., and the vacuum is pumped by a vacuum pump, and the vacuum degree is kept below 400 Pa.

Before collecting samples, the whole pipeline system was preheated for 2 h, and then the permeate was collected in a cold trap immersed in liquid nitrogen. After the experiment, the collected samples were weighed and analyzed by gas chromatography.

The total flux J and the partial flux Jᵢ of permeate are calculated by the following formula respectively:

$$J = \frac{Q}{AT}$$

$${J}_{i} = {y}_{wi} J$$

Where J is the total flux, in g/m²·h; Q is the total mass of the permeate, in kg; A is the effective area of the membrane, in m²; T is the pervaporation collection time, in h; y_{wi} is the mass fraction of component i in the permeate;

The membrane separation factor a is calculated by the mass fraction ratio of the permeate side Y and the feed side X, and is calculated by the following formula:

$$α = \frac{Yethanol / Ywater}{Xethanol / Xwater}$$

Through the above experiments, the conclusions are as follows:

Characterization of ZIF-67 and C-ZIF-67 particles:

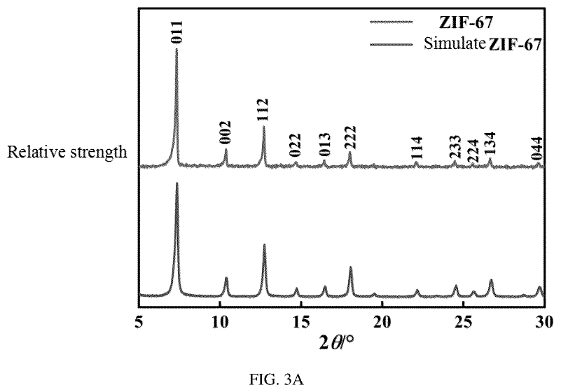

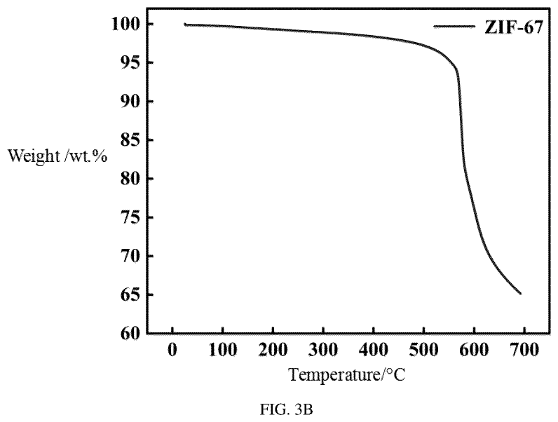

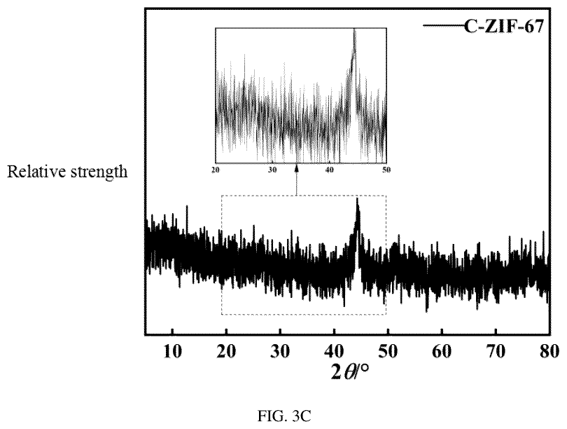

As shown in FIG. 3A-FIG. 3C, the ZIF-67 particles synthesized before and after carbonization were characterized by XRD. The characteristic diffraction peak in FIG. 3A is consistent with the spectrum of ZIF-67 in the prior art, and no other impurities exist, indicating that ZIF-67 particles have been synthesized and the diffraction peak position points to the sodalite structure.

FIG. 3B shows the TGA curve of ZIF-67 particles to analyze the thermal decomposition process of carbonization. In the range of 100-200° C., the weight of ZIF-67 particles gradually decreases due to the removal of water adsorbed in pores. The weight loss above 200° C. may be due to the escape of residual solvent from pores or the decomposition of unreacted linker. About 550° C. is the decomposition of —CH3, after 550-600° C. is the release process of C—N—H, 600-700° C. is the main decomposition and carbonization temperature, and 700° C. is the complete decomposition and carbonization.

As shown in FIG. 3C, compared with the ZIF-67 in FIG. 3A, the XRD spectrum of C-ZIF-67 shows that the characteristic peak disappears and is amorphous, and the two broad peaks at 24° and 44° are (002) and (101) phases of graphite carbon, respectively, and it is preliminarily judged that ZIF-67 has been carbonized.

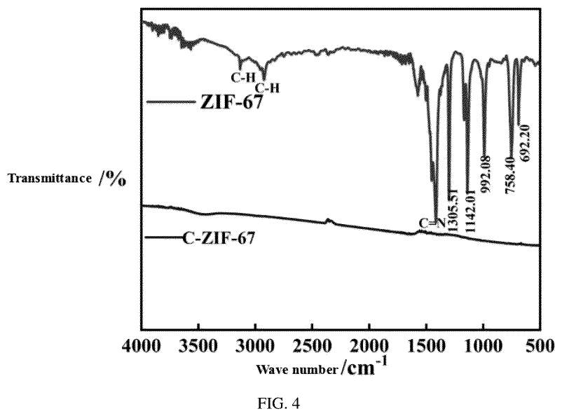

As shown in FIG. 4, the chemical structures of ZIF-67 and carbonized C-ZIF-67 particles were further studied by infrared spectroscopy. The absorption peak of ZIF-67 in FIG. 4 is mainly attributed to 2-methylimidazole ligand. The peak in the range of 600-1500 cm⁻¹ is the result of imidazole group stretching and bending vibration, and a small peak at 1460 cm⁻¹ corresponds to the stretching mode of C═N bonding. The characteristic absorption peak of synthetic particles is consistent with the results in the prior art, which further shows the successful synthesis of ZIF-67. After carbonization, the absorption peaks at the corresponding positions almost disappeared, indicating that calcination at 700° C. led to the decomposition of organic ligands, and ZIF-67 was successfully carbonized. The disappearance of characteristic groups after carbonization can reduce the influence of surface electrical properties, thus reducing the agglomeration degree of particles in MMM.

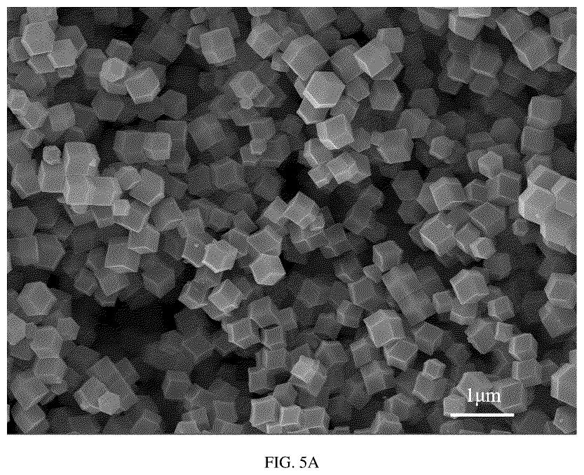

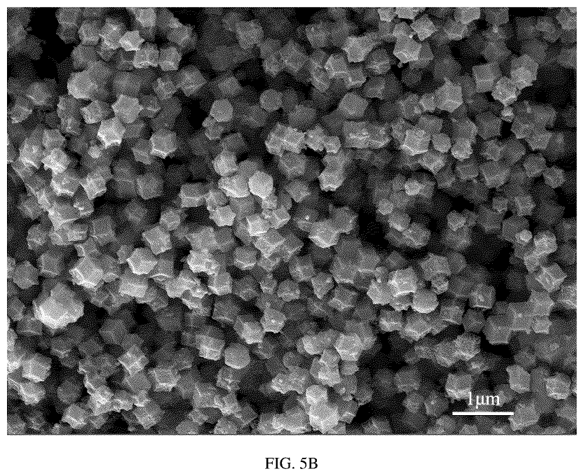

As shown in FIG. 5A-FIG. 5B, the crystal morphology of ZIF-67 is highly crystalline rhombic dodecahedron particles with sharp edges, and the size is about 300 nm. As shown in the electron microscope diagram of C-ZIF-67 in FIG. 5B, the morphology of the corresponding particles has not changed obviously, and the regular rhombic dodecahedron shape is still retained, indicating that no structural damage has occurred after carbonization, so that the original MOF skeleton structure can be used as MMM filler for further application; at the same time, it can also be seen from FIG. 5B that the particle size after carbonization is obviously reduced, which also contributes to the improvement of its dispersion in MMM.

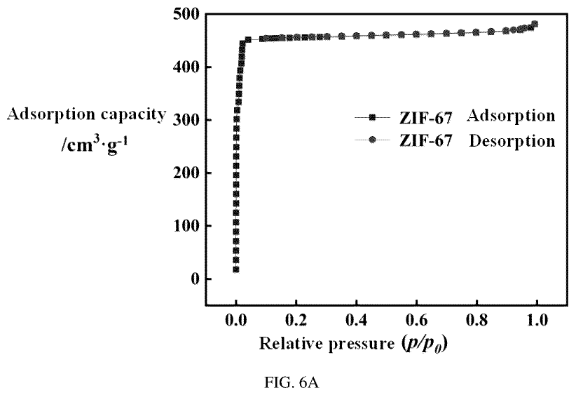

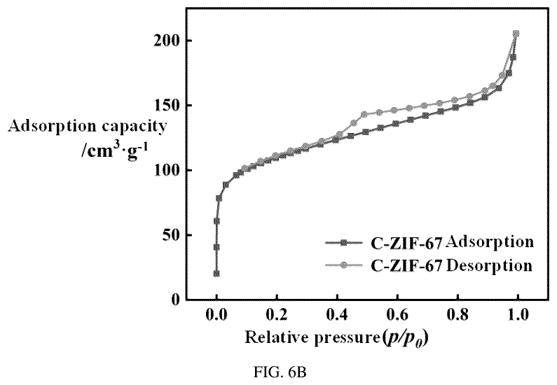

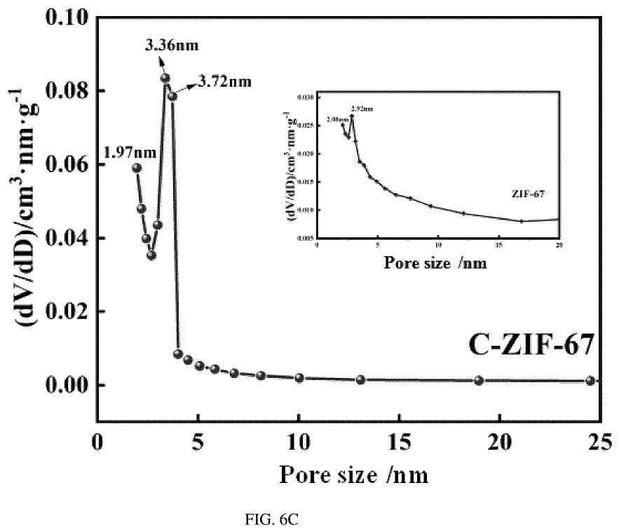

As shown in FIG. 6A, the nitrogen adsorption and desorption curve of ZIF-67 belongs to type I isotherm, indicating that it is a microporous material;

FIG. 6B is the nitrogen adsorption and desorption curve after carbonization, showing type IV isotherm and H3 hysteresis loop, which reflects that the carbonized particles are mostly mesoporous, and the pore size distribution curve of FIG. 6C also illustrates this result; As shown in the following table:

| | Total pore | Micropore | Average pore |
|---|---|---|---|
| Sample | volume/cm³g⁻¹ | volume/cm³g⁻¹ | size/nm |
| ZIF-67 | 0.7443 | 0.7039 | 2.1894 |
| C-ZIF-67 | 0.3187 | 0.1693 | 3.5774 |

### Pore Structure Characteristics of ZIF-67 and C-ZIF-67

The pore structure characteristics are given. After carbonization, the total pore volume of C-ZIF-67 is reduced from 0.7443 to 0.3187 cm³ g⁻¹, the micropore volume is reduced from 0.7039 to 0.1693 cm³ g⁻¹, and the pore volume is changed from most micropore volume to most mesopore volume. The average pore size increased from 2.18 to 3.57 nm, and the pore size distribution became wider and larger after carbonization. Combined with the above SEM results, it was shown that C-ZIF-67 particles still retained the original MOF skeleton structure, and the pore size was further enlarged compared with ZIF-67.

Characterization of membrane materials;

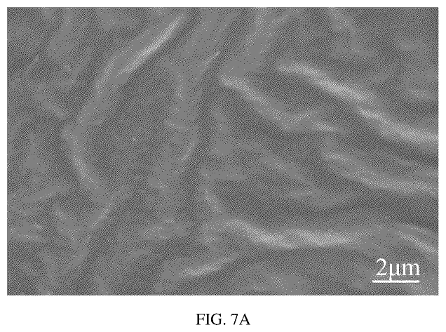

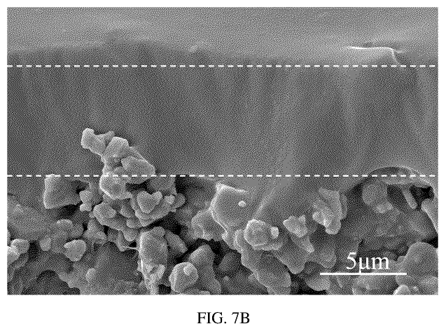

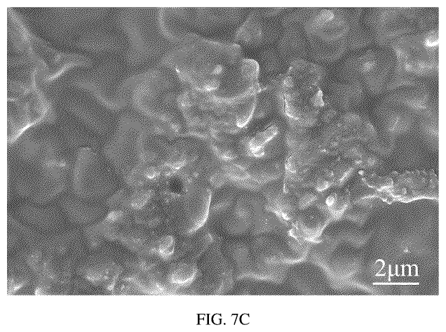

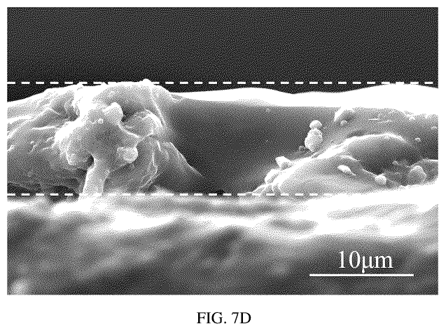

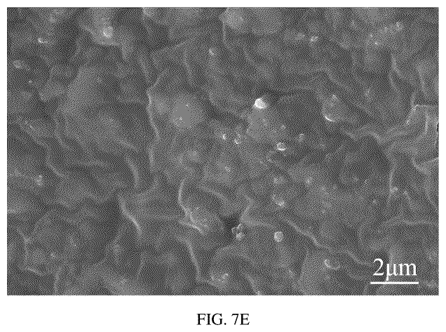

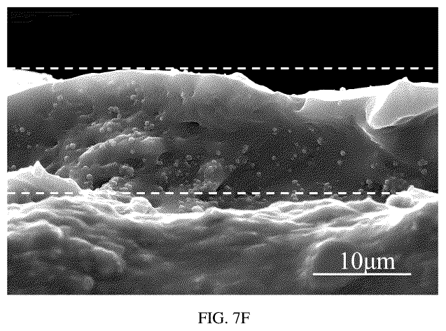

SEM morphology of PDMS membrane, ZIF-67/PDMS-15 wt % and C-ZIF-67/PDMS-15 wt % MMMs is shown in FIG. 7A-FIG. 7F. FIG. 7A and

FIG. 7B show that the surface of PDMS film is compact, smooth and defect-free, and the film thickness is about 7 μm; From the surface and cross section of ZIF-MMMs, as shown in FIG. 7C, FIG. 7D, FIG. 7E and FIG. 7F, the surface of MMMs doped with ZIF-67 and C-ZIF-67 particles becomes rough, which is consistent with the result that the water contact angle of MMMs surface becomes larger after doping particles. It is worth noting that ZIF-67/PDMS MMM has a certain degree of particle agglomeration, which further leads to the failure of some particles to form a good fusion with PDMS; in contrast, C-ZIF-67/PDMS MMM particles are less agglomerated, and C-ZIF-67 is well miscible with PDMS, which reduces the defects caused by the difficulty of viscous polymer solution penetrating the gaps between agglomerated particles. The cross section shows that the average thickness of the selective membrane of ZIF-MMMs is about 10 μm, which is thicker than that of pure PDMS membrane, and there is no obvious peeling off from the supporting layer.

Evaluation of surface hydrophobicity of ZIF-67/PDMS and C-ZIF-67/PDMS MMMs with different particle loadings by measuring water contact angle;

| Membrane | Water contact angle/° |
|---|---|
| PDMS | 115 |
| ZIF-67/PDMS-5 | 118 |
| ZIF-67/PDMS-10 | 122.4 |
| ZIF-67/PDMS-15 | 129 |
| ZIF-67/PDMS-20 | 130 |
| ZIF-67/PDMS-25 | 132 |

### Water Contact Angle of ZIF-67/PDMS MMMs

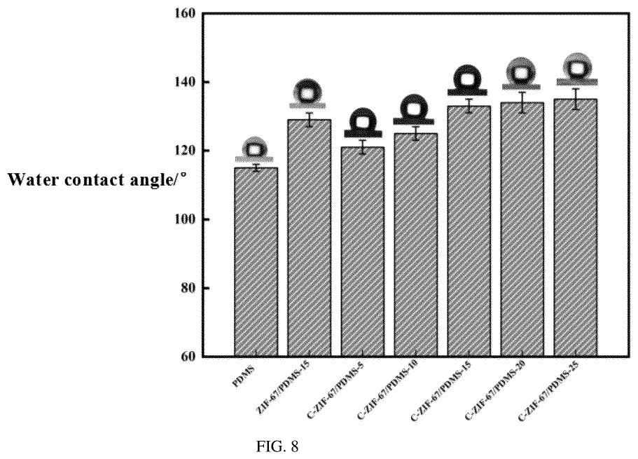

As can be seen from FIG. 8 and the above table, the water contact angle of ZIF-67/PDMS MMM is always higher than that of pure PDMS membrane (115°), which is due to the introduction of ZIF-67 particles with certain hydrophobicity and the higher roughness of the membrane surface. However, due to the inherent strong hydrophobicity of carbonized particles and good compatibility with PDMS, the water contact angle of C-ZIF-67/PDMS MMM is higher than that of ZIF-67/PDMS MMM at each loading concentration, and the water contact angle keeps increasing from 121° to 135° with the loading of filler ranging from 5% to 25%, which is due to the increasing roughness of membrane surface with the increase of loading.

### Comparison of Pervaporation Performance of Membranes;

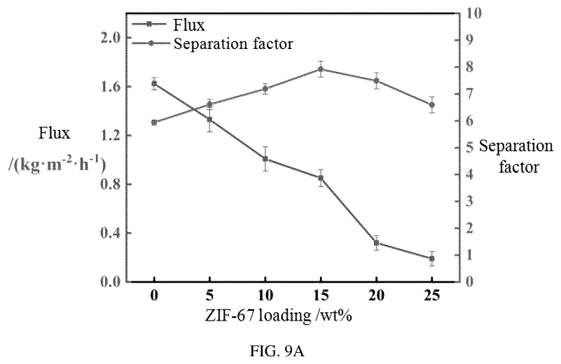

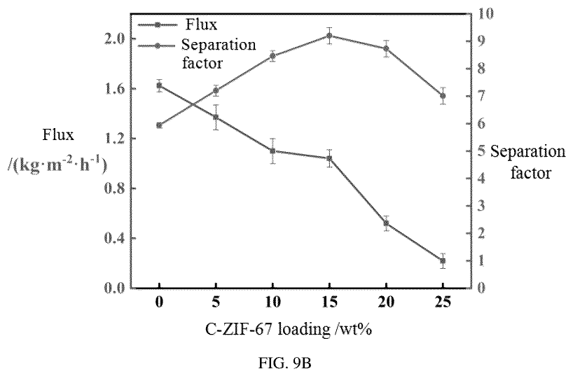

Furthermore, the pervaporation separation performance of ZIF-67/PDMS and C-ZIF-67/PDMS MMMs with different particle loadings was studied. Operating conditions: 5.0 wt % ethanol aqueous solution, 60° C.; As shown in FIG. 9A, when the loading of ZIF-67 increased from 0 to 25 wt %, the flux decreased from 1.62 to 0.19 kg/m²·h, mainly because the tubular carrier made MMM agglomerate in different degrees during the preparation process (as C-ZIF-67/PDMS MMM did);

However, MMM is prepared by sheet carrier: the mixed solution is scraped on the sheet substrate with a thickness of 150 μm for scraper to make a film, which can make the particles more evenly dispersed and greatly reduce the degree of agglomeration; on the other hand, the surface electrical properties of ZIF-67 are affected by the surface groups, which makes it easy to agglomerate, resulting in poor dispersibility, so the flux gradually decreases and is lower than that of pure PDMS membrane. The separation factor increased from 5.9 to 7.9 with the increase of particle loadings, reaching the highest, which was higher than that of pure PDMS membrane. Because ZIF-67 particles have certain hydrophobicity, the hydrophobicity of the composite membrane increases, so the separation factor increases gradually. However, when the loading of ZIF-67 increased from 15 to 25 wt %, the separation factor began to decrease, which was due to the more serious agglomeration caused by the higher loading of fillers, which led to more interface defects between ZIF-67 and PDMS. On the whole, the separation factor was improved by adding ZIF-67, but the separation selectivity was not significantly improved and the stability decreases after long-term operation because of the easy agglomeration of ZIF-67 particles and the lack of good fusion with PDMS.

The carbonized ZIF-67 particles were added to PDMS matrix to replace ZIF-67. The pervaporation performance of C-ZIF-67/PDMS MMM under different loading amounts was shown in FIG. 9B. Similarly, the separation factor increased with the increase of particle loading amounts, and began to decrease after reaching at 15 wt %, and the maximum value could reach 9.2. Compared with ZIF-67, the separation factor of each concentration is improved; the flux also decreased gradually from 1.62 to 0.21 kg/m²·h, which were lower than PDMS, but each concentration was higher than ZIF-67. Because of the inherent strong hydrophobic property, relatively good dispersibility and better compatibility with PDMS, carbon component has better separation selectivity than ZIF-67. At the same time, the large pore MOF skeleton structure and decrease of agglomeration further reduces the solution transport resistance and improves the flux.

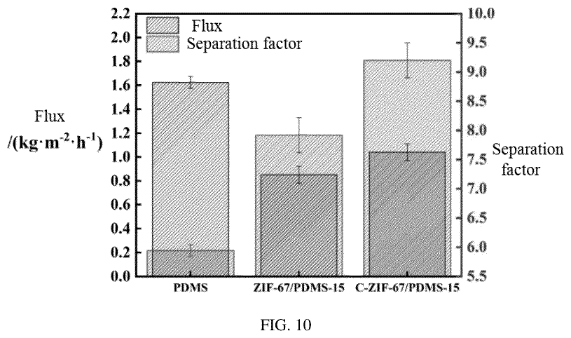

As shown in FIG. 10, the operating conditions are: 5.0 wt % ethanol aqueous solution, 60° C.; comparing the pervaporation performance of pure PDMS, ZIF-67/PDMS-15 wt % and C-ZIF-67/PDMS-15 wt % MMMs for ethanol recovery, it can be seen that the separation factor of C-ZIF-67/PDMS-15 wt % MMM is the highest, reaching 9.2; in terms of total flux, MMMs is lower than pure PDMS, but C-ZIF-67/PDMS-15 wt % MMM is higher than ZIF-67/PDMS-15 wt % MMM, reaching 1.04 kg/m²·h; on the whole, C-ZIF-67/PDMS-15 wt % MMM has the best pervaporation separation performance.

### Stability Test of C-ZIF-67/PDMS MMM;

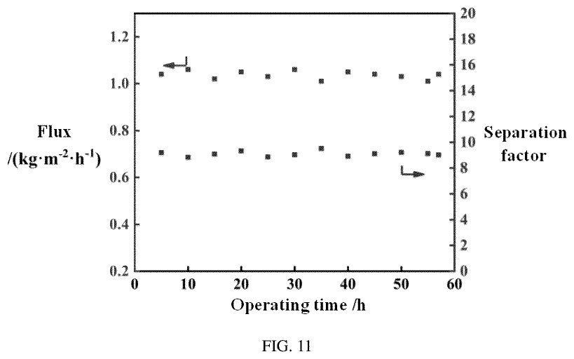

The long-term stability of membrane is very important for industrial application. Therefore, in order to evaluate the practical application potential, the long-term stability test of C-ZIF-67/PDMS MMM in 5.0 wt % ethanol aqueous solution at 60° C. was carried out. The results are shown in FIG. 11. It can be clearly seen that the separation factor and total flux remain almost unchanged for 60 h, except for some small fluctuations that may be caused by the concentration deviation of the feed solution. Although it needs to be tested for a long time before real industrialization, the above results have preliminarily indicated that C-ZIF-67/PDMS MMM has high operational stability in potential applications.

### Conclusion

In order to improve the separation performance of low concentration ethanol/water solution for pure PDMS membrane and ZIF-67/PDMS MMM, an effective method of adding C-ZIF-67 into PDMS matrix was proposed, and C-ZIF-67/PDMS MMM was successfully prepared. The carbonized particles retain the skeleton structure of the original MOF, and the pore size becomes larger. At the same time, the carbon component has strong hydrophobicity, relatively good dispersibility and better compatibility with PDMS. Compared with pure PDMS membrane and ZIF-67/PDMS MMM, the pervaporation performance of C-ZIF-67/PDMS MMM for ethanol/water solution is significantly improved. At 60° C., the pervaporation performance of MMM with 15 wt % loadings in 5 wt % ethanol aqueous solution is best, with a flux of 1.04 kg/m²·h and a separation factor of 9.2. Finally, the stability of C-ZIF-67/PDMSMMM was evaluated, and the separation factor and total flux remained almost unchanged after long-term operation. Therefore, C-ZIF-67/PDMS composite membrane has excellent properties and good application prospects.

The basic principle, main features and advantages of the present application have been shown and described above. It should be understood by those skilled in the art that the present application is not limited by the above-mentioned embodiments, and what is described in the above-mentioned embodiments and descriptions only illustrates the principles of the present application. Without departing from the spirit and scope of the present application, there will be various changes and improvements in the present application, which fall within the scope of the claimed application. The scope of that present application is define by the appended claim and their equivalents.

What is claimed is:

1. A preparation method of C-ZIF-67-derived nano-porous carbon doped PDMS mixed matrix membrane based on tubular ceramic carrier, comprising the following steps:
S1: synthesizing ZIF-67 crystal, and dissolving Co(NO₃)₂·6H₂O in methanol; then dissolve Hmim in methanol; then, the two solutions are mixed and stirred continuously for 2 h at room temperature to obtain purple crystals, the obtained purple crystals are centrifuged at 8000 rpm for 10 min to collect products, washed repeatedly with methanol, and finally the obtained crystals are dried in vacuum at 80° C. overnight to obtain ZIF-67 crystals;
S2: preparation of C-ZIF-67 filler particles: the synthesized ZIF-67 crystals are carbonized and collected, the collected particles are washed with methanol to remove residues, and finally, the C-ZIF-67 filler particles are obtained by vacuum drying at 80° C. overnight;
S3: treatment of the α-alumina ceramic tube carrier: firstly, the ceramic tube is polished with 800 #coarse sandpaper and 1500 #fine sandpaper respectively, and then the impurities are removed by calcination, and then the α-alumina ceramic tube carrier is obtained by ultrasonic cleaning for 5 min and cleaning with pure water; before use, the α-alumina ceramic tube carrier is soaked in pure water, and when needed, the excess water on the surface of the α-alumina ceramic tube carrier is wiped off with filter paper, and left to dry for later use;
S4: preparing a PDMS-based mixed matrix membrane: adding C-ZIF-67 filler particles into n-heptane, stirring, performing ultrasonic treatment for 1 h, adding PDMS and stirring for 4 h, adding PDMS into the mixed solution again, and stirring for 12 h; Subsequently, TEOS as a cross-linking agent and DBTOL as a catalyst are added respectively, and then they are allowed to stand for defoaming; the PDMS solution filled with C-ZIF-67 is coated on the outer surface of α-alumina ceramic tube carrier for 1 min by dip coating, and then it is allowed to stand at room temperature for 24 h, and then it is dried in vacuum at 90° C. for 12 h; finally, the C-ZIF-67-derived nano-porous carbon doped PDMS mixed matrix membrane is prepared.

2. The preparation method of C-ZIF-67-derived nano-porous carbon doped PDMS mixed matrix membrane based on tubular ceramic carrier according to claim 1, wherein: the amount of Co (NO₃)₂·6H₂O in S1 is 0.1-0.4 g; the methanol is 10 g-15 g; Hmim is 0.2-0.5 g.

3. The preparation method of C-ZIF-67-derived nano-porous carbon doped PDMS mixed matrix membrane based on tubular ceramic carrier according to claim 1, wherein the Co (NO₃)₂·6H₂O is 0.29 g; Methanol is 11.8 g; Hmim is 0.33 g.

4. The preparation method of C-ZIF-67-derived nano-porous carbon doped PDMS mixed matrix membrane based on tubular ceramic carrier according to claim 1, wherein the initial temperature of the ZIF-67 crystal in S2 is room temperature, the temperature is raised in nitrogen environment, the heating rate is 5° C.·min⁻¹, the temperature is raised to 700° C., the temperature is kept for 2 h, and then the temperature is naturally lowered.

5. The preparation method of C-ZIF-67-derived nano-porous carbon doped PDMS mixed matrix film based on tubular ceramic carrier according to claim 1, wherein 0.1-0.3 g of C-ZIF-67 filler particles, 20-30 g of n-heptane and 1-3 g of PDMS are added in total, and the first addition amount for PDMS is 10% of the mass of filler particles, and the second addition amount is the rest PDMS.

6. The preparation method of C-ZIF-67-derived nanoporous carbon doped PDMS mixed matrix membrane based on tubular ceramic carrier according to claim 1, wherein the particle mass of C-ZIF-67 filler is 0.2625 g, the mass of n-heptane is 25 g, and the total mass of PDMS is 1.75 g.

7. The preparation method of C-ZIF-67-derived nanoporous carbon doped PDMS mixed matrix membrane based on tubular ceramic carrier according to claim 5, wherein the mass ratio of PDMS, TEOS and DBTOL is 1:0.1:0.05.

8. The preparation method of C-ZIF-67-derived nanoporous carbon doped PDMS mixed matrix membrane based on tubular ceramic carrier according to claim 6, wherein the mass ratio of PDMS, TEOS and DBTOL is 1:0.1:0.05.

9. A method for recovering ethanol, comprising preparing a C-ZIF-67-derived nano-porous carbon doped PDMS mixed matrix membrane based on tubular ceramic carrier by the method of claim 1, and further comprising recovering ethanol by pervaporation of the C-ZIF-67-derived nano-porous carbon doped PDMS mixed matrix membrane based on tubular ceramic carrier.
